(19) United States
(12) Patent Application Publication
(10) Pub. No.: US 2025/0225653 A1
(43) Pub. Date: Jul. 10, 2025

(54) MULTI-TASK REAL-TIME INTUBATION ASSISTANT SYSTEM

(71) Applicants: KAOHSIUNG MEDICAL UNIVERSITY, Kaohsiung (TW); NATIONAL SUN YAT-SEN UNIVERSITY, Kaohsiung (TW)

(72) Inventors: Kuang-I Cheng, Kaohsiung (TW); Kao-Shing Hwang, Kaohsiung (TW); Tz-Ping Gau, Kaohsiung (TW); Ya-Chuen Shen, Kaohsiung (TW); Kuan-Yu Chen, Kaohsiung (TW); Yong-Si Xu, Hsinchu County (TW)

(21) Appl. No.: 18/407,636

(22) Filed: Jan. 9, 2024

(51) Int. Cl. G06T 7/00; G06T 7/11; G06T 7/73

(52) U.S. Cl. CPC G06T 7/0012; G06T 7/11; G06T 7/73; G06T 2207/10016; G06T 2207/30004

(57) ABSTRACT

A multi-task real-time intubation assistant system is disclosed. The system includes a laryngeal examination device, a photographic device, and a control device. The laryngeal examination device is used to enter the user's larynx for examination. The photographic device provides laryngoscopic images. The control device is connected to the photographic device and the laryngeal examination device to receive the laryngoscopic image. The control device receives the laryngoscopic images and executes a local attentive region proposal module to generate an object-detecting output. The object-detecting output corresponds to the specific organ in the larynx. A direction-detecting module is executed to generate a guiding direction for the laryngeal examination device through a direction-detecting program. A visual odometer module detects a moving distance of the photographic device through a visual odometer detecting program. The position of the laryngeal examination device is obtained by the moving distance.

### BACKGROUND OF THE INVENTION

### 1. Field of the Invention

The present disclosure relates to a multi-task real-time intubation assistant system, in particular to a multi-task real-time intubation assistant system combined with direction detection and visual odometry detection based on object detection of a local attentive region proposal module.

### 2. Description of the Related Art

As the medical personnel executes endotracheal intubation for critical patient, the images obtained either from video-laryngoscope, video-stylet, or fiberoptic bronchoscope present airway current situations and provide proper forward direction. However, due to personnel training experience in intubation or patients' anatomical situation, images provided information limited, it may be difficult for an intubator to identify the intubation situation and respond immediately. If tracheal intubation is positioning into a wrong place, the patient may result in unnecessary tissue damage, hypoxemia, evenly severe hypoxia. Those unwanted intubation-related adverse events may easily lead to medical disputes.

In the existing technology, for the images obtained from the photographic device, it is hoped to establish a 3D model of the inside of the laryngeal cavity through image analysis, which provides the operator with more assistance in determining the entry state of the device. However, the existing analytical models require a lot of computational resources for detection, which makes it difficult to meet the operator's needs in terms of operational speed. Moreover, the existing technology can neither navigate the route of the inserted equipment nor calculate the degree of movement of the equipment for positioning. Therefore, there are still considerable defects in the function of assisting the operator.

In this view, currently, the application of image analysis technology in intubation therapy is still limited and cannot effectively assist the operator in the operation. In this regard, the inventor of the present disclosure has designed a multi-task real-time intubation assistant system to tackle deficiencies in the prior art and further enhance the implementation and application in industries.

### SUMMARY OF THE INVENTION

Given the aforementioned conventional problem, the present disclosure provides a multi-task real-time intubation assistant system to solve the problem that the conventional image analysis technology can hardly deal with multiple tasks, such as object recognition, direction guidance, and equipment localization in real time.

According to one purpose of the present disclosure, provided is a multi-task real-time intubation assistant system, including a laryngeal examination device, a photographic device, and a control device. The laryngeal examination device is used to enter a larynx of a user for examination. The photographic device photographs the larynx from a travel direction of the laryngeal examination device to produce a laryngoscopic image. The control device is connected to the photographic device and the laryngeal examination device to receive the laryngoscopic image, wherein the control device includes a processor and a memory, and the processor accesses positioning and navigation commands of the memory to execute following modules: a local attentive region proposal (LARP) module, a direction-detecting module, and a visual odometer module. The local attentive region proposal module extracts a network output feature map of the laryngoscopic image through a feature extractor, generates a regional localization through an attention recurrent mechanism (ARM), scans the regional localization through a region proposal network (RPN) to generate a region of interest (RoI), and inputs the region of interest into the detector for classification and regression to generate an object-detecting output, wherein the object-detecting output corresponds to a specific organ within the larynx. The direction-detecting module generates a guiding direction of the laryngeal examination device through a direction-detecting program. The visual odometer module detects a moving distance of the photographic device through a visual odometer detecting program and positions the laryngeal examination device by the moving distance.

Preferably, the direction-detecting program may include a symmetry-detecting program or a groove edge-detecting program.

Preferably, the symmetry-detecting program may horizontally flip the laryngoscopic image by a scale-invariant feature transformation (SIFT) algorithm and compares feature points to obtain a symmetry line.

Preferably, the groove edge-detecting program may detect edge line segments on both sides by Canny Edge Detection and Probability Hough Transform and generates a guide line from the edge line segments on both sides.

Preferably, when the local attentive region proposal module generates the object-detecting output, the direction-detecting program may use the symmetry line of the symmetry-detecting program as the guiding direction.

Preferably, when the local attentive region proposal module does not generate the object-detecting output, the direction-detecting module may determine whether a preset organ has been outputted; if yes, the direction-detecting program uses the guide line of the groove edge-detecting program as the guiding direction; if no, the direction-detecting module uses the symmetry line of the symmetry-detecting program as the guiding direction. The preset organ may be a uvula.

Preferably, the visual odometer detecting program may compare feature points by an LK pyramid optical flow algorithm to calculate a rotation matrix and translation vector, and then obtains scale information by a checkerboard as an initial value to generate the moving distance.

Preferably, the specific organ may include a uvula, epiglottis, arytenoid cartilage, or vocal cord.

Preferably, the multi-task real-time intubation assistant system may further include a display device connected to the control device, wherein the display device may display the laryngoscopic image and positioning and navigation information of the laryngeal examination device.

As mentioned above, the multi-task real-time intubation assistant system of the present disclosure may have one or more following advantages:
(1) The multi-task real-time intubation assistant system may detect objects through the local attentive region proposal module and reduce a great number of computational resources required for global detection through sequential searching, thus increasing the computing speed to achieve timely detection.
(2) The multi-task real-time intubation assistant system may obtain the guidance route and positioning location of the laryngeal examination device through the direction-detecting module and visual odometer module, thereby providing operators with clearer and more accurate navigational and operational information, avoiding entering the wrong path during operation that injures other organs, and improving the safety of system operation.
(3) The multi-task real-time intubation assistant system may present the system analysis results through the display interface, thus providing the operator with real-time and accurate image and model analysis information, facilitating the operator's convenience while in operation.

### BRIEF DESCRIPTION OF THE DRAWINGS

To make the technical features, content, and advantages of the present disclosure and the achievable effects more obvious, the present disclosure is described in detail together with the drawings and in the form of expressions of the embodiments as follows:

FIG. 1 is a block diagram of a multi-task real-time intubation assistant system according to an embodiment of the present disclosure.

FIG. 2 is a schematic diagram of the local attentive region proposal module according to an embodiment of the present disclosure.

FIG. 3 is a schematic diagram of the feature extraction network according to an embodiment of the present disclosure.

FIG. 4 is a framework diagram of the attention recurrent mechanism according to an embodiment of the present disclosure.

FIG. 5 is a schematic diagram of the direction-detecting module and a visual odometer module according to an embodiment of the present disclosure.

FIG. 6 is a detection flowchart of the direction-detecting module according to the embodiment of the present disclosure.

FIG. 7 is a block diagram of a multi-task real-time intubation assistant system according to another embodiment of the present disclosure.

### DESCRIPTION OF THE PREFERRED EMBODIMENTS

To illustrate the technical features, contents, advantages, and achievable effects of the present disclosure, the embodiments together with the accompanying drawings are described in detail as follows. However, the drawings are used only to indicate and support the specification, which is not necessarily the real proportion and precise configuration after the implementation of the present disclosure. Therefore, the relations of the proportion and configuration of the accompanying drawings should not be interpreted to limit the actual scope of implementation of the present disclosure.

Unless otherwise defined, all terms used herein (including technical and scientific terms) have the meanings commonly understood by a person with ordinary skill in the art. It should be further understood that, unless explicitly defined herein, the terms such as those defined in commonly used dictionaries should be interpreted as having definitions consistent with their meaning in the context of the related art and the present disclosure, and should not be construed as idealized or overly formal.

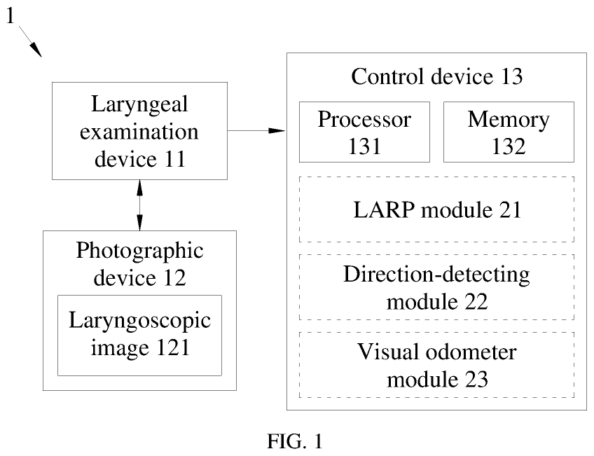

Please refer to FIG. 1, which is a block diagram of a multi-task real-time intubation assistant system according to an embodiment of the present disclosure. As shown, the multi-task real-time intubation assistant system 1 includes a laryngeal examination device 11, a photographic device 12, and a control device 13. The laryngeal examination device 11 is used to enter the user's larynx for examination, such as a laryngoscope, a stylet, a fiberscope, etc. The photographic device 12 photographs the larynx from a travel direction of the laryngeal examination device 11 to produce a laryngoscopic image 121. The photographic device 12 may be various image-capturing devices, such as a video camera, a camera, an endoscope, etc., the lens of which is mounted on the laryngeal examination device 11 and directed toward the larynx. When the laryngeal examination device 11 enters the larynx, the insertion status of the laryngeal examination device 11 is inspected through the laryngoscopic image 121 captured by the photographic device 12.

The control device 13 is connected to the photographic device 12 and the laryngeal examination device 11 to receive the laryngoscopic image 121, wherein the control device 13 includes a processor 131 and a memory 132, and the processor 131 accesses positioning and navigation commands of the memory 132 to execute the local attentive region proposal (LARP) module 21, the direction-detecting module 22, and the visual odometer module 23. The local attentive region proposal module 21 extracts a network output feature map of the laryngoscopic image through a feature extractor, generates a regional localization through an attention recurrent mechanism (ARM), scans the regional localization through a region proposal network (RPN) to generate a region of interest (RoI), and inputs the region of interest into the detector for classification and regression to generate an object-detecting output, wherein the object-detecting output corresponds to a specific organ within the larynx. Compared to the existing technology of object detection that requires global detection of images, leading to excessive computing resources, the present disclosure focuses on specific regions of interest by the attention recurrent mechanism and deep-enhancing learning, and the final result is generated by the detector's algorithm. The image is observed sequentially by being divided into regions by simulating the process of the human eye, and whether the corresponding specific organ, such as a uvula, epiglottis, arytenoid cartilage, or vocal cord, exists in the region is confirmed.

The direction-detecting module 22 and the visual odometer module 23 serve as modules for positioning and navigation, and the direction-detecting module 22 generates the guiding direction of the laryngeal examination device 11 through a direction-detecting program. The visual odometer module 23 detects a moving distance of the photographic device 12 through a visual odometer detecting program and positions the laryngeal examination device 11 by the moving distance, to confirm the position of the laryngeal examination device 11 in the laryngeal cavity and prevent the operator from making mistakes when operating the laryngeal inspection device 11, such as accidentally entering the esophagus, causing an inability to breathe that leads to medical accidents. The following embodiments further describe the contents of each processing module.

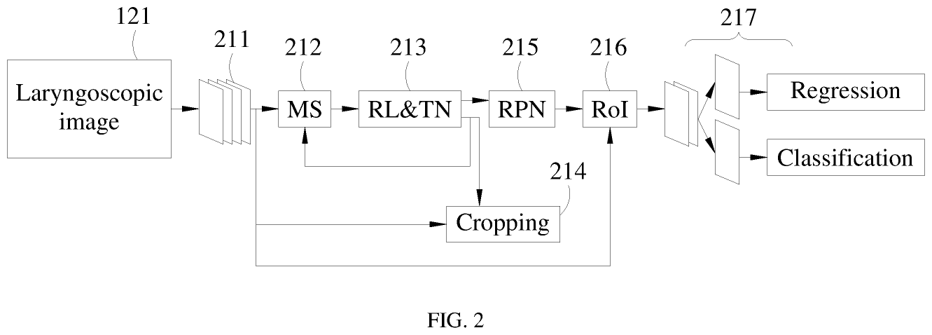

Please refer to FIG. 2, which is a schematic diagram of the local attentive region proposal module according to an embodiment of the present disclosure. As shown, for the operation mechanism of the local attentive region proposal module 21, the laryngoscopic image 121 is inputted first, and feature extraction is performed through the feature extractor 211 to generate a network output feature map, which is in the masked state (MS) 212. Each region is accessed by regional localization and termination network (RL&TN) 213, and cropping 214 is performed on the regional localization until the search is terminated. Region of interest (RoI) 216 is generated by regional localization through the scanning of the region proposal network (RPN) 215, and the results of the region of interest (RoI) 216 are then inputted into a detector 217. Regression and classification are performed through the operational layer of the replication and fully connected layers to generate classification results corresponding to specific objects, that is, specific organs such as uvulas, epiglottises, arytenoid cartilages, or vocal cords. The entire process, just like the human eye, sequentially observes photos into regions, which is faster and more reasonable than the method of global observation.

In the feature extractor 211, the feature extraction network used may include the feature extraction network used in Fast R-CNN, such as vgg16, res101, FPN, etc., but the present disclosure is not limited thereto, so the feature extractor 211 may be connected to any feature extraction network. Taking vgg16 as an example, the network from conv1 to con5-x is used as the convolutional layer, the fully connected layer of vgg16 together with two parallel fully connected layers is used as the detector 217, and when an image of size (h₀, w₀) is inputted to the feature extraction network, a feature map of size (h, w, 512) will be obtained, and the size difference in between is 16 times. In res101, the network from conv1 to con4-x is used as the convolutional layer, two parallel fully connected layers are added to con5-x of res101 as the detector 217, and when an image of size (h₀, w₀) is inputted to the feature extraction network, a feature map of size (h, w, 1024) will be obtained, and the size difference in between is 16 times.

In practice, the performance of res101 is better than that of vgg16, but the output dimension of res101 is twice larger than that of vgg16, which results in a longer follow-up runtime when the state space becomes larger. In this regard, the concept of feature pyramid networks (FPN) is considered to construct the feature extraction network of FPN@P4. The feature pyramid networks include a bottom-up pathway, a top-down pathway, and a lateral connection. The bottom-up pathway is a method of feature extraction networks such as vgg16 and res101, etc., which obtains a multi-dimensional feature map through feed-forward calculation, gradually reducing the length and width and increasing the depth of the input image. The top-down pathway performs up-coming on the high-level feature maps to obtain the same scale as the lower-level feature maps and then combines the low-level feature maps through horizontal connections.

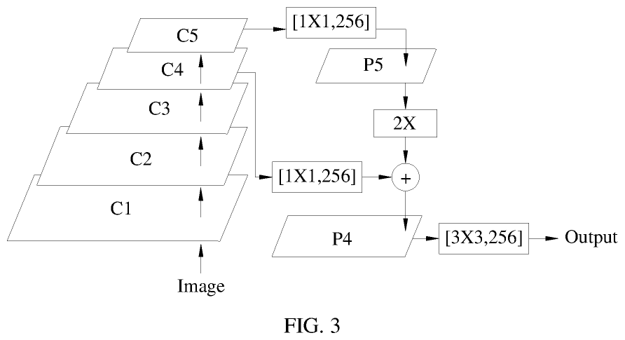

Please refer to FIG. 3, which is a schematic diagram of the feature extraction network according to an embodiment of the present disclosure. As shown, the bottom-up pathway is convolutional layers C1, C2, C3, C4, and C5, such as conv1 to con5-x in the vgg16 network, and the top-down pathway is feature maps P4 and P5. The convolutional layer C5 outputs the feature map P5 with a depth of 256 through the convolutional kernel of [1×1, 256]. After two times up-coming, the length and width of the feature map are the same as those of the convolutional layer C4. Through the horizontal connection, the feature map P4 is obtained by adding the feature map outputted by the convolutional layer C4 through the convolutional kernel of [1×1, 256]. The final output is obtained after the convolution with the convolutional kernel of [3×3, 256]. For the detector 217, two 1021-d fully connected layers together with two parallel fully connected layers are used. In the feature extraction network, the content outputted by the high-level convolutional layer is provided with more semantic information. However, the relative positional information is less accurate, whereas the output from the low-level convolutional layer has less semantic information but more accurate positional information. In the present embodiment, through constructing the feature extraction network of FPN@P4, the advantages of high-level and middle-low layers may be well integrated, and the dimensionality may be reduced, thus making the entire calculational process run faster.

In the regional localization and termination network 213, the present embodiment adopts the attention recurrent mechanism (ARM), and the attention recurrent mechanism sequentially pays attention to critical regions based on the attention mechanism and the search model of reinforcement learning, which stops after the completion of the search is determined and finally outputs the local region to which is paid attention. If no termination is made, regional localization is utilized to select a region where the object is believed to exist, which is then inputted to the region proposal network 215. The framework of the attention recurrent mechanism is to be described below.

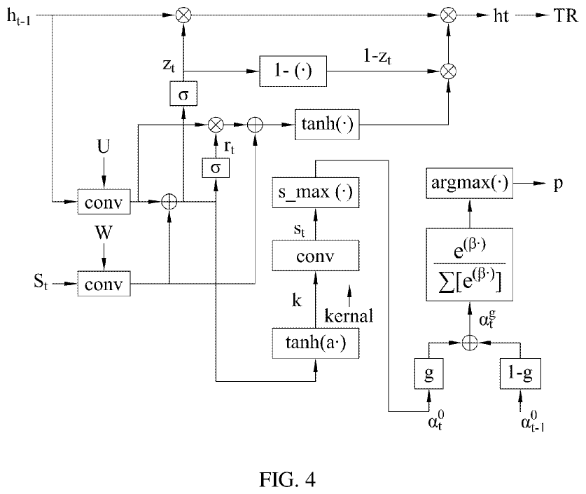

Please refer to FIG. 4, which is a framework diagram of the attention recurrent mechanism according to an embodiment of the present disclosure. As shown, the input of the attention recurrent mechanism is the hidden state hₜ₋₁ and state Sₜ(feature map) of the previous moment; after the hidden state and the state are respectively calculated using convolutional operation, they are added up and inputted to the attention path to output the regional localization p. The search termination TR is generated through the output of the hidden state hₜ in the attention recurrent mechanism to determine whether the program is terminated.

The attention mechanism is mainly divided into the soft attention mechanism and the hard attention mechanism. The soft attention mechanism generates a distribution of proportions between features after a feature map generated by an image is inputted. The numerical value from 0 to 1 indicates which region in the image should be paid attention to, as well as which region would disappear after multiplying the output of the soft attention mechanism, thus ignoring irrelevant regions. In this process, numerical values are continuous and parameterizable, so the soft attention mechanism may be trained using a gradient descent method. As for the hard attention mechanism, after the feature map is inputted, a distribution of proportions between features is generated, and the maximum value is taken as the output. The process is not continuous and may not be differentiated, so reinforcement learning is utilized for training. In the present embodiment, the attention recurrent mechanism combines a soft attention mechanism and a hard attention mechanism, and because of the hard attention mechanism, reinforcement learning is utilized for training.

In terms of regional localization in the lower half of the framework, the attention recurrent mechanism adds up the state Sₜ and the hidden state hₜ₋₁ which are respectively calculated using convolutional operation. Then, the excitation function tanh is utilized to limit the output value between 1 and −1, as shown in Equation (1).

$${k}_{t} = tanh [ a * ( {W}_{k} ⊗ {S}_{t} + {U}_{k} ⊗ {h}_{t - 1} ) ] \qquad ( 1 )$$

This equation is α gate, which adjusts the concentration or dispersion of data by multiplying the function tanh by the parameter a. After kₜ is obtained, it is inputted into the convolutional layer to get sₜ, and then the excitation function softmax is used to input sₜ to obtain an output attention proportion vector αₜ⁰ between 0 and 1. Further, the attention proportion vector at the previous moment αₜ₋₁⁰ and the attention proportion vector at the present moment αₜ⁰ are multiplied by 1−g and g respectively and weighted to obtain αₜ^{g}, as shown in Equation (2) and Equation (3).

$${α}_{t}^{0} = softmax ( kernal ⊗ {k}_{t} ) \qquad ( 2 )$$

$${α}_{t}^{g} = g * {α}_{t}^{0} + ( 1 - g ) * {α}_{t - 1}^{0} \qquad ( 3 )$$

αₜ^{g} is normalized and used as β gate, as shown in Equation (4).

$$A = {e}^{β \cdot {α}_{t}^{g}} / \sum {e}^{β \cdot {α}_{t}^{g}} \qquad ( 4 )$$

The larger β, the more extreme the output result would be. Finally, the result is averaged down, and the coordinate of the maximum value is selected as the regional localization p for output, as shown in Equation (5) and Equation (6).

$${α}_{i} = softmax ( {\sum }_{j} {A}_{i , j} ) , i = 1 , 2 … , h * w , A ∈ {R}^{( h * w ) \times {d}_{b a s e}} \qquad ( 5 )$$

$$p = arg max {α}_{i} \qquad ( 6 )$$

In terms of the recurrent neural network in the upper part of the framework, the attention recurrent mechanism adds up the state Sₜ and the hidden state hₜ₋₁ which are respectively calculated using convolutional operation. The excitation function sigmoid is inputted to limit the value between 0 and 1 to obtain remade valve parameters rₜ and updated valve parameters zₜ, as shown in Equation (7) and Equation (8).

$${r}_{t} = σ ( {W}_{r} ⊗ {S}_{t} + {U}_{r} ⊗ {h}_{t - 1} ) \qquad ( 7 )$$

$${z}_{t} = σ ( {W}_{z} ⊗ {S}_{t} + {U}_{z} ⊗ {h}_{t - 1} ) \qquad ( 8 )$$

A dot multiplication is performed on the product after the convolutional operation of the remade valve parameters and the hidden state hₜ₋₁, which is added to the product after the convolutional operation of the state Sₜ, and \tilde{h}ₜ is obtained after this result is activated with the excitation function tanh, as shown in Equation (9).

$${\tilde{h}}_{t} = tan ( {W}_{h} ⊗ {S}_{t} + {r}_{t} ( {U}_{h} ⊗ {h}_{t - 1} ) ) \qquad ( 9 )$$

\tilde{h}ₜ includes information on the current state Sₜ and the last hidden state hₜ₋₁ after selection, which is equivalent to memorizing the current information. Finally, \tilde{h}ₜ and the hidden state hₜ₋₁ are respectively multiplied by 1−zₜ and zₜ, respectively representing how much current information is memorized and how much past information is forgotten. Then, the results are added up to output the hidden state hₜ as the input of the hidden state at the next moment, as shown in Equation (10).

$${h}_{t} = {z}_{t} * {h}_{t - 1} + ( 1 - {z}_{t} ) * {\tilde{h}}_{t} \qquad ( 10 )$$

The regional localization and termination network include the attention recurrent mechanism and are trained through deep reinforcement learning. The input state must be defined first, which includes the state Sₜ and the hidden state hₜ₋₁ outputted at the previous moment, where S₀ is the feature map outputted by the feature extraction network, d_{base} is the feature map thickness, and h×w is the feature map size. Whenever the state is updated, −1 is placed on the local region that has been seen as a basis for being paid attention to, thus completing the state transfer.

In judging the regional localization and search termination, the search termination is obtained by hₜ generated by the attention recurrent mechanism; hₜ first passes through two layers of convolution (Equation (11)), which is then scaled to fix the size to output Tₜ(Equation (12)); after Tₜ is multiplied by W_{d}, the search termination TR is outputted through the function sigmoid (Equation (12)). If TR is greater than 0.5, the program terminates, and if TR is not greater than 0.5, the program continues.

$${T}_{t}^{′} = tanh ( {W}_{{T}^{′}} ⊗ rel u ( {W}_{{h}^{′}} ⊗ {h}_{t} + {b}_{{h}^{′}} ) + {b}_{{T}^{′}} ) \qquad ( 11 )$$

$${T}_{t} = resize ( {T}_{t}^{′} ) \qquad ( 12 )$$

$$TR = σ ( {W}_{T} {T}_{t} ) \qquad ( 13 )$$

Region localization is obtained by p generated by the attention recurrent mechanism, and p is set as the center of the regional localization. A rectangle is drawn with a length of 0.25h and a width of 0.25w around as the expected regional localization output, making the rear region proposal network 215 scan to generate a region of interest 216. Output is made when TR is not greater than 0.5. When TR is greater than 0.5, output is stopped, and the program is determined.

During the operation of regional localization and termination network, initialization is needed so that the program may obtain a non-zero initial value h₀ to prevent the first output region center from being positioned at (0,0). In addition, in the hope that the agent makes the Intersection-over-Union (IoU) of the predicted region of interest 216 and the ground truth as large as possible without wanting the agent to glimpse too much to improve IoU, which wastes time and generates useless regions of interest 216, a reward is design and proposed. gᵢ is the ith ground truth in the first photo, Iⁱ is the maximum between all regions of interest and IoU of gᵢ in the photo from the beginning to the present, Iₜⁱ is the maximum between all regions of interest and IoU of gᵢ in the photo at time t, rₜ^{p} is the reward for regional localization, rₜ^{TR} is the reward for ending the action, τ is the threshold of IoU set to 0.5, and β is the penalty set to 0.05. To improve the IoU, if it is Iₜⁱ>Iⁱ, meaning that the IoU may increase when one glimpse is made, the reward rₜ^{p} may be given; to reduce the number of views, penalty rₜ^{TR} may be made for each more glimpse. When the program stops operating, the results are summarized. If the minimum value of Iⁱ is greater than the threshold τ, it means that the corresponding ground truth has been found, and the reward rₜ^{TR} will be given. If the minimum value of Iⁱ is less than the threshold τ, it means that the complete corresponding ground truth has not been found at the end of the program, and penalty rₜ^{TR} will be given.

The local attentive region proposal module 21 will first load the weights trained by Fast R-CNN during initialization, including the feature extractor 211, the region proposal network 215, and the detector 217. Next, the regional localization and termination network 213 and the detector 217 will be trained, and the feature extractor 211 and the region proposal network 215 will remain unchanged. In the present embodiment, each batch size is 1, meaning that only one image is used for training in one iteration. In the first phase of training, an enhanced training method is adopted for regional localization and termination network 213 training. After one iteration, the cumulative return Rₜ corresponding to this iteration is outputted, as shown in Equation (14), showing a summarization of the positioning rewards for each region and the search termination rewards in the iteration after discounting.

$${R}_{t} = {\sum }_{k = 0}^{∞} {γ}^{k} ( {γ}_{t + k + 1}^{p} + {γ}_{t + k + 1}^{T R} ) , γ = 0 \text{.95} \qquad ( 14 )$$

Where γ is the attenuation rate, t is time, and k is which glimpse to use for viewing photos; when fifty iterations are completed, the parameters θ_{H} are updated using strategy gradient and Adam optimization algorithm. The objective function here, also the loss function, may be represented by Equation (15), which is made up of Equation (14) combined with the subsequent Equation (16) to Equation (18).

$$J ( {θ}_{H} ) \approx - {\sum }_{t = 1}^{t r a j} [ {L}_{p} ( {p}_{t} , {p}_{t}^{*} ) {\overline{R}}_{t} + {L}_{T R} ( {a}_{t}^{T R} , {a}_{t}^{T {R}^{*}} ) {\overline{R}}_{t} ] \qquad ( 15 )$$

$${L}_{p} ( {p}_{t} , {p}_{t}^{*} ) = - {p}_{t}^{*} log {p}_{t} \qquad ( 16 )$$

$${L}_{T R} ( {a}_{t}^{T R} , {a}_{t}^{T {R}^{*}} ) = - {a}_{t}^{T {R}^{*}} log {a}_{t}^{T R} - ( 1 - {a}_{t}^{T {R}^{*}} ) log ( 1 - {a}_{t}^{T R} ) \qquad ( 17 )$$

$${\overline{R}}_{t} = \frac{{R}_{t} - batch\_means ( {R}_{t} )}{batch\_std ( {R}_{t} )} \qquad ( 18 )$$

In Equation (16), measures of dispersion between the sampling results of regional localization and the prediction probability thereof are evaluated by cross-entropy. In Equation (17), measures of dispersion between the sampling results of search termination and the prediction probability thereof are evaluated by cross-entropy. Equation (18) is the normalized cumulative return obtained from the average and standard deviation accumulated by Rₜ after fifty iterations.

In the second phase, the regional localization and termination network 213 and the detector 217 will be trained, and the training method of the regional localization and termination network 213 is the same as that in the first phase as mentioned above. The detector 217 is first trained using the generated region of interest 216, each iteration may be trained once, and the loss function of the detector 217 is shown in Equation (19).

$$L ( {θ}_{D} ) = L ( o , c , {b}^{c} , z ) = {L}_{c l s} ( o , c ) + [ c \geq 1 ] {L}_{l o c} ( {b}^{c} , z ) \qquad ( 19 )$$

Where o is a predicted value for categories with a total of K+1, and b^{k}=(bₓ^{k}, b_{y}^{k}, b_{w}^{k}, bₕ^{k}) is the amount of border correction for each category; x, y, w, and h are the center coordinates and width and length of the prediction box, c is the category of ground truth, and z is the ground truth of the amount of border correction; the detector is updated using the momentum optimization algorithm, with the momentum being 0.9 and weight attenuation being 1e-4. Equation (19) of the loss function may be made up of Equation (20) to Equation (22).

$${L}_{c l s} ( o , c ) = - log {o}_{c} \qquad ( 20 )$$

$${L}_{l o c} ( {b}^{c} , z ) = {\sum }_{i ∈ \{ x , y , w , h \}} {smooth}_{L 1} ( {b}_{i}^{c} - {z}_{i} ) \qquad ( 21 )$$

$${smooth}_{L 1} ( x ) = \{ \begin{matrix}0.5 {x}^{2} & if \vert x \vert < 1 \\ \vert x \vert - 0.5 & otherwise\end{matrix} \qquad ( 22 )$$

Equation (20) is the loss function of categorization, and Equation (21) is the loss function of border regression. Since c=0 is the background, the background is removed by [C≥1]. In general, the square loss function or the absolute loss function may be selected for border regression. Here, Equation (22) is used, which may have a fine output no matter what the value is.

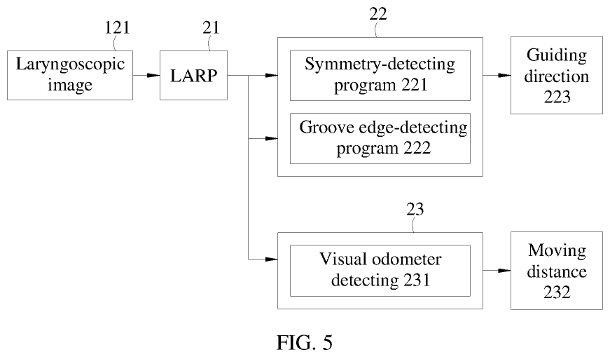

Please refer to FIG. 5, which is a schematic diagram of the direction-detecting module and a visual odometer module according to an embodiment of the present disclosure. As shown, the laryngoscopic image 121 is firstly inputted into the local attentive region proposal module 21. After the object-detecting output is generated, it enters into the direction-detecting module 22, and the guiding direction 223 is generated through the symmetry-detecting program 221 or the groove edge-detecting program 222. On the other hand, the object-detecting output also enters the visual odometer module 23. The moving distance 232 of the photographic device is confirmed through the visual odometer detecting program 231, so that the control device may mark the position of the laryngeal examination device on the schematic diagram of the human laryngeal cavity through the aforementioned information, which helps the operator to have a more accurate understanding of the status of the insertion step of the laryngeal examination device to avoid injuring other organs due to incorrect entry routes.

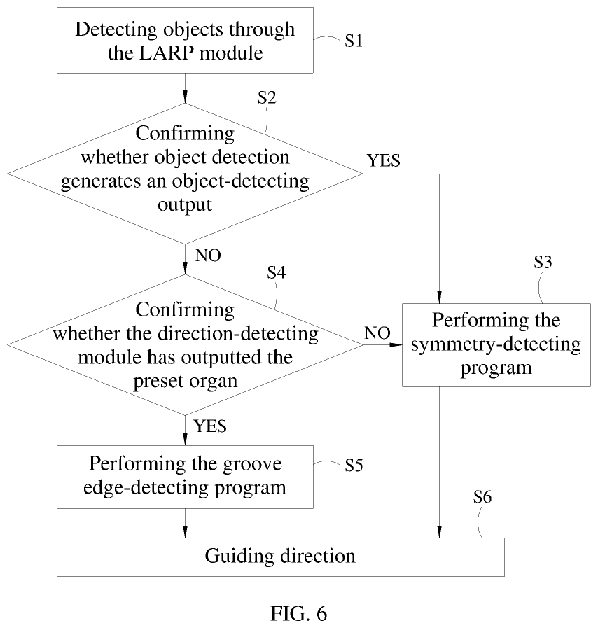

In the direction-detecting module 22, the judgment procedure to be used is determined according to whether the local attentive region proposal module 21 produces an object-detecting output. Please refer to FIG. 6, which is a detection flowchart of the direction-detecting module according to the embodiment of the present disclosure. As shown, the direction-detecting module 22 may include the following steps (S1-S6):

Step S1: detecting objects through the local attentive region proposal module. According to the aforementioned embodiments, the laryngoscopic image 121 is detected through the local attentive region proposal module 21, and the detecting result is inputted to Step 2 to confirm whether an object-detecting output is generated, that is, whether a specific organ is detected, for example, a uvula, epiglottis, arytenoid cartilage, or vocal cord.

Step S2: confirming whether object detection generates an object-detecting output. If yes, move to step S3; if no, move to step S4. The object-detecting output generated in the output result of the local attentive region proposal module 21 indicates that a specific organ is detected in the laryngoscopic image 121. Since the inside of the oral cavity is symmetrical, symmetry detection is performed by capturing detection parts, that is, moving to step S3. If the specific organ is not detected, move to step S4 to further confirm whether the preset organ, such as the uvula, has been viewed.

Step S3: performing the symmetry-detecting program. The symmetry-detecting program flips the input image horizontally by the scale-invariant feature transform (SIFT) algorithm. The matching points and symmetry points are found in the flipped image from the feature points in the original image. After the two points are connected, a vertical line is taken at the connection center as the symmetry line. Multiple feature points may be set in the original image. After all the feature points are detected, the symmetry line will be voted to find out the highest vote as the output based on the angle and length.

Step S4: confirming whether the direction-detecting module has outputted the preset organ. If no, move to step S3; if yes, move to step S5. When the laryngeal examination device enters the mouth and reaches the epiglottis, it is expected to detect the uvula through the local attentive region proposal module 21, so the symmetry-detecting program will be performed until the uvula is detected. When the uvula is detected, since the direction to which the uvula points is the epiglottis, the groove edge-detecting program will be performed until the epiglottis, which is the endpoint, is found. Therefore, when the object-detecting output does not detect a specific organ, the system needs to confirm whether the uvula of the preset organ has been seen to further determine a detecting method to be used. If the uvula has not been exported, the symmetry-detecting program is used; if detected, the groove edge-detecting program is used.

Step S5: performing the groove edge-detecting program. In the process from the uvula to the epiglottis, a road-shaped line will be formed on the left and right sides. Therefore, based on this feature, the edge line segments on both sides are detected by the Canny Edge Detection and Probability Hough Transform, and the line segments on the left and right sides are calculated respectively to obtain a guide line accordingly. The method in detail is to first convert the image into greyscale, remove the noise by a Gaussian filter, and use the Canny Edge Detection to find possible edges in the image. Then, the Probability Hough Transform is used to find the places that may be line segments, and straight-line fitting is performed on the found line segments to find the line segments on the left and right sides. Finally, the angles are averaged to obtain guide line segments.

Step S6: generating a guiding direction. The symmetry line or guide line found by the aforementioned symmetry-detecting program or groove edge-detecting program may be used as the guiding direction of the laryngeal examination device when entering the laryngeal cavity. For instance, the uvula is found through the guidance by the symmetry line of the symmetry-detecting program, and then the epiglottis is guided through the guide line of the groove edge-detecting program, allowing the laryngeal examination device to enter the larynx correctly through the guiding direction. During the entire process, the output direction angle may be processed by the Kalman filter to make the output result more stable without excessive oscillation.

In the visual odometer module 23, the visual odometer detecting program 231 compares feature points through the LK pyramid optical flow algorithm, calculates the rotation matrix and translation vector, and then uses the checkerboard as the initial value to obtain the scale information to generate the moving distance. Since the monocular visual odometer lacks a scale factor, only the forward direction of the camera may be predicted, which fails to predict the actual moving distance. Therefore, before the oral cavity is entered, the photographic device is used to shoot a checkerboard of known size and detect the grid points of the checkerboard. Since the perimeter of the region surrounded by the checkerboard points is known, the detected checkerboard points use the perimeter as a basis to calculate the 3D coordinates of the 2D feature points on the map. After the essential matrix and camera pose are solved, the corresponding rotation matrix and unit coordinates are outputted by the camera motion function. Further, the conversion ratio between the circumference surrounded by 3D point coordinates and the actual length is multiplied by the actual 3D coordinates and displacement to restore the scale of the actual 3D coordinates and displacement.

After having the initial displacement scale, by comparison with the feature points, that is, using the LK pyramid optical flow algorithm, solving the essential matrix, and solving the camera pose, the next scale factor is calculated through Equation (23) and Equation (24).

$$s {x}_{n} = {R}_{n - 1 , n} \overline{{x}_{n - 1}} - {sR}_{n - 1 , n} t \qquad ( 23 )$$

$${R}_{n - 1 , n} s t + {t}_{n - 1 , n} = 0 \qquad ( 24 )$$

$$s = \frac{( {R}_{n - 1 , n} \overline{{x}_{n - 1}} ) \cdot ( {x}_{n} + {R}_{n - 1 , n} t )}{‖ {x}_{n} + {R}_{n - 1 , n} t ‖} \qquad ( 25 )$$

Wherein, x̅ₙ̅₋̅₁̅ is the 3D point coordinates of the scale achieved at the previous moment, xₙ is the 3D point coordinates of the scale that has not been restored at the present moment, R_{n-1,n} is the rotation matrix that converts coordinates n−1 to n, and t is the unit coordinate of the photographic device at the nth time seen from the n−1 coordinate system. After sorting, the scale factor s is calculated using Equation (25) as the calculation method. Finally, the sₜ whose scale has been restored is accumulated after each frame to restore the actual location of the shooting device as a calibration of the positioning function.

As time increases and the moving feature points of the shooting device gradually decrease, the 3D feature points are transmitted to construct the next scale factor. The transfer matrix and translation matrix for this time are used as a basis to perform triangulation and find out new 3D feature points. This method may be used to re-detect feature points through the AKAZE algorithm, and the feature points are compared through the LK pyramid optical flow algorithm to obtain two new sets of feature points before and after.

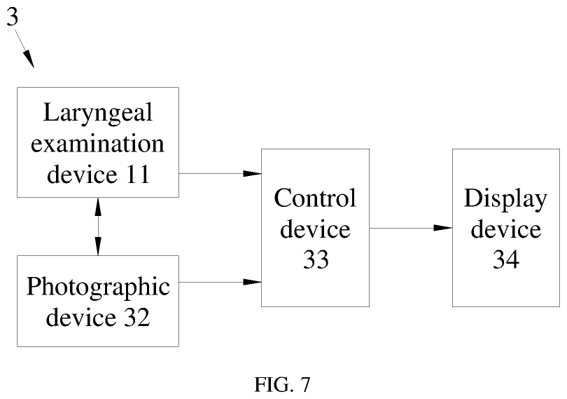

Please refer to FIG. 7, which is a block diagram of a multi-task real-time intubation assistant system according to another embodiment of the present disclosure. As shown, the multi-task real-time intubation assistant system 3 includes a laryngeal examination device 31, a photographic device 32, a control device 33, and a display device 34. The laryngeal examination device 31 is used to enter the user's larynx for examination, such as a laryngoscope, stylet, fiberscope, etc. The photographic device 32 photographs the larynx from a travel direction of the laryngeal examination device 31 to produce a laryngoscopic image. The photographic device 32 may be various image-capturing devices, such as a video camera, a camera, an endoscope, etc., the lens of which is mounted on the laryngeal examination device 31 and directed toward the larynx. When the laryngeal examination device 31 enters the larynx, the insertion status of the laryngeal examination device 31 is inspected through the laryngoscopic image captured by the photographic device 32.

The control device 33 is connected to the photographic device 32 and the laryngeal examination device 31 to receive the laryngoscopic image. The local attentive region proposal (LARP) module, direction-detecting module, and visual odometer module are performed through the internal processor and memory to generate navigation and positioning content of the laryngeal examination device. The operation of each module is similar to those in the previous embodiments, the same content of which shall not be described repeatedly. In the present embodiment, the multi-task real-time intubation assistant system 3 may be disposed with a display device 34, and the display device 34 is connected to the control device 33 to display laryngoscopic images or positioning and navigation information of the laryngeal examination device 31.

The display device 34 may be a display interface of the control device 33, such as a screen of a computer device, or the display device 34 may also be an independent display device 34, such as various kinds of handheld devices. The detecting results of the control device 33 are received through the wireless communication network, and the larynx image captured by the photographic device 32 and the positioning and navigation information of the laryngeal examination device 31 generated by the module calculation are shown through the display interface. The operator, such as medical staff, may refer to the image displayed on the display device 34 while operating the laryngeal examination device 31 to help determine the operating direction and position of the laryngeal examination device 31, thus avoiding accidentally injuring other organs during the operation. In addition to real-time display status, the control device 33 or the display device 34 may also be equipped with a data storage device for recording and photographing, which allows the operator to re-check the status of the laryngeal examination device 31 when operated each time, thus achieving the effect of teaching, training, or learning.

The above description is merely illustrative rather than restrictive. Any equivalent modifications or alterations without departing from the spirit and scope of the present disclosure are intended to be included in the following claims.

What is claimed is:

1. A multi-task real-time intubation assistant system, comprising:
a laryngeal examination device, used to enter a larynx of a user for examination;
a photographic device, photographing the larynx from a travel direction of the laryngeal examination device to produce a laryngoscopic image; and
a control device, connected to the photographic device and the laryngeal examination device to receive the laryngoscopic image, wherein the control device comprises a processor and a memory, and the processor accesses positioning and navigation commands of the memory to execute following modules:
a local attentive region proposal module, extracting a network output feature map of the laryngoscopic image through a feature extractor, generating a regional localization through an attention recurrent mechanism, scanning the regional localization through a region proposal network to generate a region of interest, and inputting the region of interest into the detector for classification and regression to generate an object-detecting output, wherein the object-detecting output corresponds to a specific organ within the larynx;
a direction-detecting module, generating a guiding direction of the laryngeal examination device through a direction-detecting program; and
a visual odometer module, detecting a moving distance of the photographic device through a visual odometer detecting program, and positioning the laryngeal examination device by the moving distance.

2. The multi-task real-time intubation assistant system according to claim 1, wherein the direction-detecting program comprises a symmetry-detecting program or a groove edge-detecting program.

3. The multi-task real-time intubation assistant system according to claim 2, wherein the symmetry-detecting program horizontally flips the laryngoscopic image by a scale-invariant feature transformation algorithm and compares feature points to obtain a symmetry line.

4. The multi-task real-time intubation assistant system according to claim 3, wherein the groove edge-detecting program detects edge line segments on both sides by Canny Edge Detection and Probability Hough Transform and generates a guide line from the edge line segments on both sides.

5. The multi-task real-time intubation assistant system according to claim 4, wherein when the local attentive region proposal module generates the object-detecting output, the direction-detecting program uses the symmetry line of the symmetry-detecting program as the guiding direction.

6. The multi-task real-time intubation assistant system according to claim 4, wherein when the local attentive region proposal module does not generate the object-detecting output, the direction-detecting module determines whether a preset organ has been outputted; if yes, the direction-detecting program uses the guide line of the groove edge-detecting program as the guiding direction; if no, the direction-detecting module uses the symmetry line of the symmetry-detecting program as the guiding direction.

7. The multi-task real-time intubation assistant system according to claim 6, wherein the preset organ is a uvula.

8. The multi-task real-time intubation assistant system according to claim 1, wherein the visual odometer detecting program compares feature points by an LK pyramid optical flow algorithm to calculate a rotation matrix and translation vector, and then obtains scale information by a checkerboard as an initial value to generate the moving distance.

9. The multi-task real-time intubation assistant system according to claim 1, wherein the specific organ comprises a uvula, epiglottis, arytenoid cartilage, or vocal cord.

10. The multi-task real-time intubation assistant system according to claim 1, further comprising a display device connected to the control device, wherein the display device displays the laryngoscopic image and positioning and navigation information of the laryngeal examination device.
